(19) United States
(12) Patent Application Publication
(10) Pub. No.: US 2013/0067237 A1
(43) Pub. Date: Mar. 14, 2013

(54) PROVIDING RANDOM ACCESS TO ARCHIVES WITH BLOCK MAPS

(71) Applicants: Ruke Huang, Redmond, WA (US); Simon Wai Leong Leet, Redmond, WA (US); Marko Panic, Seattle, WA (US); Kin-Yip Kenneth Wong, Redmond, WA (US)

(72) Inventors: Ruke Huang, Redmond, WA (US); Simon Wai Leong Leet, Redmond, WA (US); Marko Panic, Seattle, WA (US); Kin-Yip Kenneth Wong, Redmond, WA (US)

(73) Assignee: Microsoft Corporation, Redmond, WA (US)

(21) Appl. No.: 13/230,607

(22) Filed: Sep. 12, 2011

(51) Int. Cl. H04L 9/00; G06F 7/00

(52) U.S. Cl. 713/189; 707/667; 707/E17.005

(57) ABSTRACT

Objects of an object set stored in an archive may be randomly accessed using the addresses of the objects stored in the archive. However, archives often fail to enable random access to the data within an object, without accessing other portions of the object, due to the variable compression of respective segments of the object. Random-access capabilities within the objects may be provided by segmenting the object into segments of a segment size, generating a block map specifying the block sizes of respective blocks corresponding to respective segments of the objects, and storing the block map in the archive as an object of the object set. Additionally, hashcodes may be calculated respective blocks and included in the block map in order to expose alterations of respective blocks, and/or to update an archive to an updated version of the archive by comparing the hashcodes and retrieving and substituting the updated blocks.

### BACKGROUND

Within the field of computing, many scenarios involve the storage of an object set comprising objects compressed within an archive using a compression technique. The archive comprises a concatenation of the compressed versions of the objects, each preceded by a local header describing the object (e.g., the filename, the compression technique selected for the object, and the compressed size), and may include a central directory including a set of centralized headers that identify the addresses of the local headers. In order to extract an object from the archive, an archive extractor may read the central directory, identify the address within the archive of the local header of the object, seek within the archive to the address of the compressed data, and apply the compression technique to expand the compressed object. In this manner, the archive extractor is capable of providing random access to the objects stored in the archive; e.g., accessing a particular object in the archive does not involve the other objects in the archive.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

The format of an archive may promote random access to particular objects within a particular archive (e.g., by reading the central directory, identifying the location within the archive of the particular object, and seeking within the file to the location). However, in many cases, the format of an archive does not enable random access within a particular object stored in the archive, but only permits sequential access within the compressed data. For example, respective portions of the object may be compressible to different degrees, resulting in an unpredictable correlation of regularly spaced offsets within the uncompressed object with locations within the compressed object, and such correlational information may be unobtainable without decompressing the object.

This incapacity may be disadvantageous in some scenarios. For example, a media object may be stored in a compressed manner in an archive, and a media rendering application, such as a streaming media application, may endeavor to seek within the archive to a particular location within the media object (e.g., a particular timecode or frame of a video recording, or a particular track of an album recorded as a single object). However, because different portions of an object are compressed with a variable compression ratio (based on the regularity of the data included in the portion), the archive extractor may be unable to identify the location of the selected portion within the compressed version of the object in the archive. Rather, the archive extractor may have to expand the compressed data of the object sequentially until reaching the selected portion. The lack of information about the compression of an object therefore comprises inefficiency when an archive extractor is invoked to access a randomly selected portion of an object stored in an archive. Additionally, while the format of the archive may include a cryptographic signature of respective objects of the archive, and may therefore enable an identification of changes to the objects following the generation of the archive (e.g., due to tampering or data corruption), the signature may be once for each object, and may therefore not enable a determination of which portions of the object have changed. These and other limitations may arise from the storage of coarse-granularity metadata within the archive representing the objects as monolithic entities.

Presented herein are techniques for enabling random access within objects of an object set that are stored in an archive. In accordance with these techniques, for an object to be compressed into an archive, an embodiment of these techniques may first select a segment size that, within the uncompressed version of the object, defines periodic locations into which a random seek may be sought. For example, if the segment size is defined as 64 kilobytes, an archive extractor may be capable of randomly seeking to any 64-kilobyte boundary within the object while the object remains compressed. This selection therefore conceptually segments the object into a sequence of segments of a fixed size. An archive generator may, while invoking a compression technique to compress the object, record the sizes of the compressed blocks of data corresponding to each segment. The archive generator may then add to the archive a block map that identifies the block sizes of the blocks of the compressed object that correspond to respective segments of the uncompressed object. Notably, the block map may be included in the archive as an additional object of the object set, e.g., as an inserted file in an archived file set, having an entry in the central directory in an equivalent manner with the other objects of the archive.

When a request is received to access a selected portion of the object, an archive extractor may identify the uncompressed segment of the object where the selected portion begins. The archive extractor may then examine the block map to identify the block sizes of the blocks leading up to the block corresponding to the selected portion. The archive extractor may then read this block (and any subsequent blocks corresponding to other segments of the compressed object that also include the portion), invoke the compression technique to expand these blocks, and provide the uncompressed data in response to the request. In this manner, random access to arbitrarily selected portions of the object may be enabled.

Additional functions may also be achieved through the encoding of block information as a block map. For example, when the archive is extracted, the block map may be extracted and stored as an object (e.g., a file) along with the other objects of the object set. The block map, as a discrete object, may have various uses. As a first such example, the block map may be formatted in a human-readable manner (e.g., an extensible markup language (XML) document), and a human may examine the contents of the block map to identify information about the blocks of the objects, and to create tools that may automatically consume and utilize the information in the block map. As a second such example, an original archive may be updated by comparing the original block map with an updated block map of an updated archive; identifying which blocks have changed between the original archive and the updated archive; and automatically requesting, receiving, and incorporating updated blocks that have changed between the original archive and the updated archive. As a third such example, the block map may include verifiers (e.g., hashcodes) for respective blocks based on the contents of each block when archived, and may use such verifiers to determine which portions of respective objects have been altered since the archive was generated. These and other uses of the block map may enable additional functionality of the archive according to the techniques presented herein.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary scenario featuring a set of objects stored in and/or extracted from an archive.

FIG. 2 is an illustration of an exemplary scenario featuring a set of objects stored in and extracted from an archive having a block map in accordance with the techniques presented herein.

FIG. 3 is a flow chart illustrating an exemplary method of generating an archive compressing at least one object in accordance with the techniques presented herein.

FIG. 4 is a flow chart illustrating an exemplary method of fulfilling a request to read at least one selected segment of a selected object compressed with a compression technique stored in an archive having a block map in accordance with the techniques presented herein.

FIG. 5 is an illustration of an exemplary computer-readable medium comprising processor-executable instructions configured to embody one or more of the provisions set forth herein.

FIG. 6 is an illustration of an exemplary scenario featuring a calculation of a block address of a block using a block table among a set of objects compressed with a compression technique.

FIG. 7 is an illustration of an exemplary scenario featuring a comparison of hashcodes of respective blocks in order to verify the contents of the segments.

FIG. 8 is an illustration of an exemplary scenario featuring a comparison of original hashcodes of respective blocks of an archive with hashcodes of updated blocks of an updated archive in order to update the archive to the updated archive.

FIG. 9 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

### A. Introduction

Within the field of computing, many scenarios involve the generation of an archive, comprising a set of objects compressed according to one or more compression techniques. A user or process may designate a set of objects and invoke an archive generator, which may examine respective objects, select a suitable compression technique based on the nature of the object, and invoke the compression technique to generate a compressed version of the object. For some objects (e.g., those comprising data that has already been compressed), the use of any additional compression technique may achieve insubstantial or negative compression and at the expense of unfruitful computation, so the object may be stored in the archive in an uncompressed state. The archive generator generates the archive, comprising, for respective objects, a local header (describing the object and the compression technique utilized) and the compressed object, and concluding with a central directory, comprising a set of central headers that again describe the objects contained in the archive, including the addresses of the local headers of the objects and the compression technique used for each object (or the lack of a compression technique for objects that are stored in the archive in an uncompressed state).

A compressed object may be extracted from an archive by an archive extractor in the following manner. First, the archive extractor reads the central directory to identify the address of the local header of the object within the archive, the compressed size of the object, and the compression technique utilized to store the object in the archive. The archive extractor then seeks to the local header and reads the contents of the local header in order to advance to the address where the compressed data for the object begins. The archive extractor may then read the compressed data for the object, and may invoke the compression technique on the compressed data to regenerate the uncompressed object. In this manner, and due to the identifiable location of the central directory within the archive that specifies the locations of the local headers of the objects included in the archive, the format of the archive enables an archive extractor to extract a single object or a subset of objects without having to examine or extract the other objects of the archive.

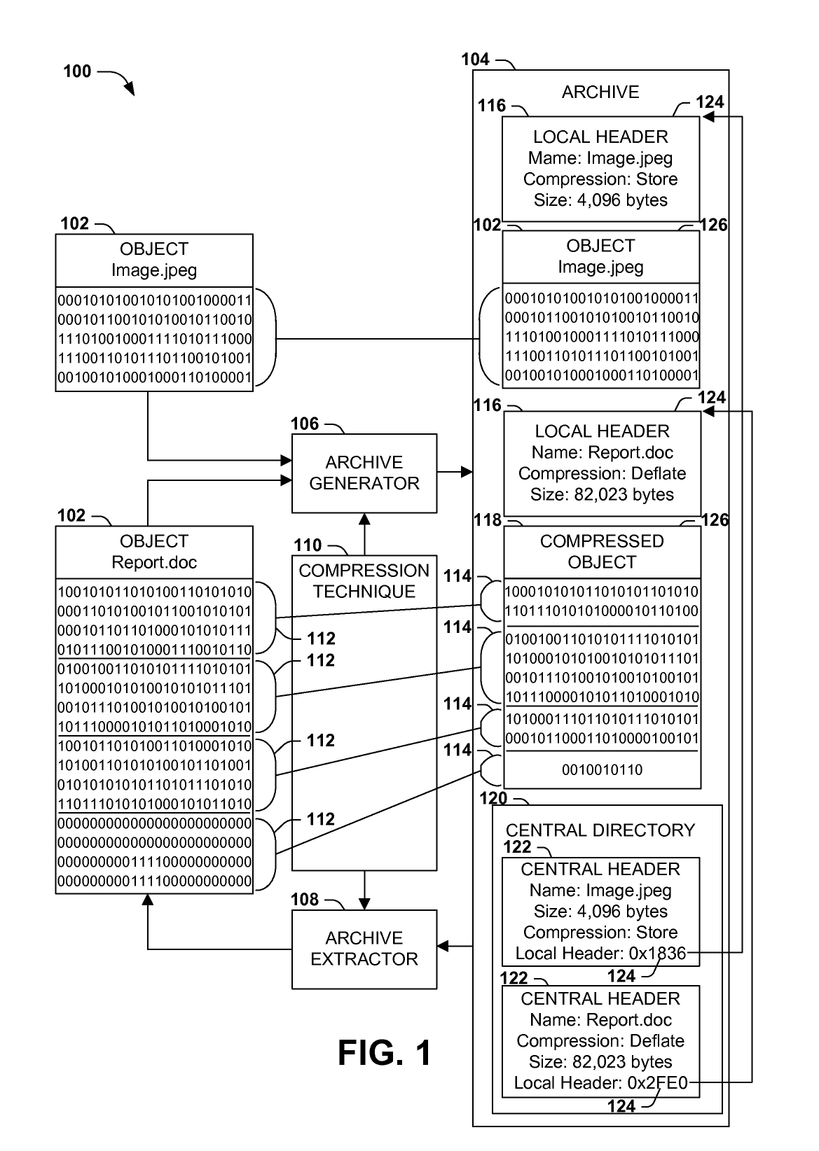

FIG. 1 presents an illustration of an exemplary scenario 100 featuring a first object 102 (“Image.jpeg”) and a second object 102 (“Report.doc”) to be stored in an archive. To each object 102, an archive generator 106 may apply a compression technique 110 to generate a compressed object 118, and may store the compressed objects 118 in the archive 104. Each object 102 may include data formatted in a particular manner that may affect the compression thereof. For example, the data comprising the second object 102 may be comparatively uncompressed, such that applying a compression technique 110 to the second object 102 may result in a compressed object 118 of a significantly smaller size. However, the data of the first object 102 may already be compressed, such that applying a compression technique 110 to the first object 102 may generate a compressed object 118 that is not significantly smaller (or may even be larger than the uncompressed object due to the overhead of the compression technique 110), yet that can only be utilized by expanding it to regenerate the first object 102, thereby consuming computational resources without significant benefit. Accordingly, for the second object 102, the archive generator 106 may store the compressed object 118 in the archive 104, but for the first object 102, the archive generator 106 may instead store the first object 102 in an uncompressed format. Moreover, the archive generator 106 may utilize a variety of compression techniques 110, each of which may be adept at compressing a particular type of data, and may select an appropriate compression technique for each object 102 based on the nature of the data contained therein.

In order to generate an archive 104, the archive generator 106 accepts a set of objects 102, and generates an archive 104 comprising a sequence of compressed objects 118, each preceded by a local header 116 that describes various properties of the compressed object 118, e.g., a name of the object 102 (e.g., a filename to be assigned to the uncompressed object 102 when extracted from the archive 104, and optionally including a location of the object 102 within the archived set of objects 102, such as a folder or subfolder where the object 102 is to be located upon expansion); the compression technique 110 used to generate the compressed object 118; and the compressed size of the compressed object 118. Additionally, the archive generator 106 appends to the sequence of compressed objects 118 a central directory 120, comprising a sequence of central headers 122, each again describing the compressed object 118 and the address of the local header 116 within the archive 16. Conversely, in order to extract a particular object 102 from an archive 104, an archive extractor 108 examines the central directory 120 and locates the central header 122 for the object 102. The archive extractor 108 then seeks to a local header address 124 of the local header 116 for the compressed object 118 and advances past the local header 116 to a start address 126, where the data comprising the compressed object 118 begins. The archive extractor 108 then invokes the compression technique 110 to expand the compressed object 118 in order to regenerate the object 102. In this manner, the archive generator 106 and the archive extractor 108 interoperate to achieve the compression of objects 102 in an archive 104 and the extraction therefrom.

A particular advantage to the techniques presented in the exemplary scenario 100 of FIG. 1 involves the capability of the archive extractor 108 to achieve random access to the compressed objects 118 stored in an archive 104. For example, the first compressed object 118 is stored after the second compressed object 118 in the archive 104, but in order to extract the first object 102, the archive extractor 108 does not have to examine or extract the second compressed object 118. By referring to the central header 122 for the first compressed object 118 stored in the central directory 120, the archive extractor 108 may identify the local header address 124 for the first compressed object and may directly seek within the archive 104 to this local header address 124. This configuration may be advantageous, e.g., in order to enable rapid access in the same manner to any object 102 stored in the archive 104, regardless of where and how the compressed object 118 is stored within the archive 104, and regardless of the numbers and sizes of compressed objects 118 stored before and after the compressed object 118. Because archives 104 may scale up to contain many objects 102, and/or may contain very large compressed objects 118 (perhaps spanning into several gigabytes), the capability of random access to any compressed object 118 without regard to the other compressed objects 118 in the archive 104 may significantly improve the efficiency of the archive extractor 108.

However, the capability of random access to an object 102 stored in an archive 104 may not include the capability of random access within the object 102, and may only include sufficient information to permit sequential access to the data comprising the compressed object 118. While the information contained in the central directory 120 of the archive 104 enables the archive extractor 108 to identify, rapidly and efficiently, a start address 126 of the data comprising a compressed object 118, this information does not enable the archive extractor 108 to seek within the archive 104 to an address corresponding to a particular location within the compressed object 118 in order to extract a particular portion of the object 102. Moreover, the archive extractor 108 may not be capable of inferring or calculating the address due to the variable compression rate of the compression technique 110. For a particular object 102, different segments 112 of the object 102 may compress with different degrees of compaction, each resulting in a block 114 of compressed data having a variable block sizes. For example, in the exemplary scenario 100 of FIG. 1, the first object 102 may comprise four segments 112 of data having a uniform size. However, each segment 112 may be compressed by the compression technique 110 into a block 114 having a variable block size; e.g., the first segment 112 may compress into a first block 114 with a modest compression ratio of 50%, while the second segment 112 may not compress at all and may result in a second block 114 with a 0% compression ratio (e.g., having a block size equaling the segment size of the second segment 112). Conversely, a fourth segment 112, comprising data of a highly uniform pattern, may compress tightly into a fourth block 114 having an 89% compression ratio. While the variable sizing of the blocks 114 results in a high degree of compression, these variable sizes also prevent an archive extractor 108 from inferring or calculating the location of a particular block 114 within the compressed object 118 corresponding to a particular segment 112 of the object 102.

The inability to achieve random access of a selected portion of a compressed object 118 may cause significant disadvantages for a compression technique 110. As a first example, if only a small portion of the compressed object 118 is desired (e.g., an object 102 stored within a first archive 104 that is in turn stored in a second archive 104), the archive extractor 108 may have to extract the entire compressed object 118 from the archive 104 and extract the selected portion therefrom. This process is inefficient, and may involve a significant amount of computing resources, e.g., if the selected portion is only a small portion of the compressed object 118. As a second example, the archive 104 may be invoked by a streaming process that provides a data stream of the data comprising an object 102, e.g., a video recording having key frames, which may be stored within the archive 104. However, the streaming process may not be able to access a desired portion of the compressed object 118 within the archive 104 on a random-access basis, but may instead have to invoke the archive extractor 108 to extract the entire compressed object 118 up to the desired location of data to be streamed. This inefficiency may arise repeatedly, e.g., where the streaming process involves a series of requests to access a sequence of particular portions within the compressed object 118.

Other limitations may also arise in the use of an archive 104 of an object set. As a first example, an update of the archive 104 may be applied (e.g., the original archive 104 may comprise a compressed set of resources for an application, and an updated archive 104 may be generated comprising a later version of the application with alterations to only some objects). The archive 104 may enable a determination of which objects 102 have changed in the updated archive 104, e.g., by comparing a file modification date or size, or hashcodes of the objects 102 stored in the local header 116 of the compressed 118 and/or in the central directory 120. However, it may be difficult to determine which portions of an object 102 have been changed in an updated archive 104, but may only determine whether or not an entire object 102 has changed. As a result, updating the archive 104 may involve retrieving the entirety of one or more updated objects 102, even if the objects 102 are large and only a small portion of the object 102 has been updated. As a second example, it may be difficult to verify that the contents of an archive 104 have not been altered since it was generated, e.g., that neither data corruption nor malicious activity has results in a change to one or more compressed objects 118 or the central directory 120. Some archives 104 may include hashcodes for respective compressed objects 118, which may respectively represent the contents of respective compressed objects 118 as a monolithic entity, and may be used to detect a change in the contents of the object has occurred since the generation of the compressed object 118. However, such hashcodes do not indicate where a change has occurred within a compressed object 118, but only that a change has occurred somewhere within the compressed object 118. These and other limitations may arise from the generation of an archive 104 similar to the archive 104 presented in the exemplary scenario 100 of FIG. 1.

### B. Presented Techniques

Presented herein are techniques for storing objects 102 within an archive 104 that enables an archive extractor 108 to achieve random access to a desired portion of data stored within a compressed object 118 by including information within the archive 104 that enables an archive extractor 108 to calculate, within a compressed object 118, the address of a block 114 corresponding to a particular segment 112. In order to achieve this capability, the archive generator 106 segments the object 102 into regularly sized segments 112 of a segment size (e.g., eight-kilobytes segments 112). The archive generator 106 may then track the block sizes of blocks 114 generated by the compression technique 110 and corresponding to such segments 112. This information may be stored in the archive 104 as a block map, which may be added to the archive 104 in a similar manner to any object 102 of the object set (e.g., by adding the block map to a central directory of the archive). An archive extractor 108 may then utilize this information to calculate, within a compressed object 118, the address of a block 114 corresponding to any segment 112 of the object 102. The archive 104 may seek within the archive 104 to this address, extract only this block 114, and invoke the compression technique 110 to expand the block 114 to regenerate the segment 112. In this manner, the configuration of the archive generator 106 to generate and store a block map for one or more compressed objects 118 enables the archive extractor 108 to extract any particular block 114 of a compressed object 118 without regard to the other blocks 114 of the compressed object 118, thereby achieving random access into the compressed object 118.

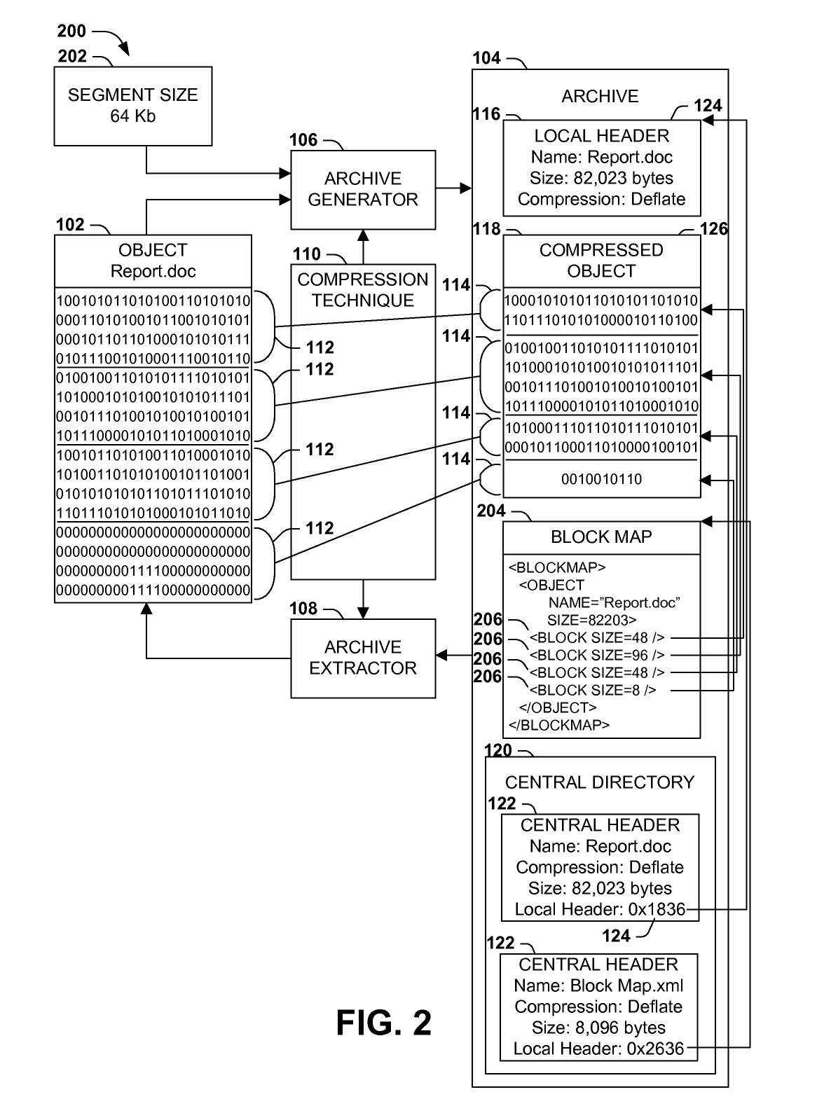

FIG. 2 presents an illustration of an exemplary scenario 200 featuring an application of these techniques to achieve random access into a particular portion of a compressed object 118 stored in an archive 104. In this exemplary scenario 200, an archive generator 106 may be invoked to generate an archive 104 storing a compressed version of an object 102, and may invoke a compression technique 110 to compress the object 102. However, in this exemplary scenario 200, the archive generator 106 also identifies a segment size 202 specifying the sizes of segments 112 within the object 102. While invoking the compression technique 110 to compress the object 102, the archive generator 106 may generate a block map 204 identifying the block sizes 206 of the sequence of blocks 114 comprising the compressed object 118, along with some additional information, such as the name of the object 102 and the size of the uncompressed object 102. The archive generator 106 may store include the block map 204 in the archive 104 as an object 102 of the object set. An archive extractor 108 may utilize the block map 204 to identify, within the compressed object 118, the address of a particular block 114 corresponding to a particular segment 112 of the object 102. For example, in order to access the fourth segment 112 of the object 102 in the archive 104, the archive extractor 108 reads the central directory 120, locates the central header 122 for the compressed object 118, and reads from the central header 122 the local header address 124 of the compressed object 118. The archive extractor 108 then seeks to the local header address 124 of the local header 116 of the compressed object 118 and advances past the local header 116 to the start address 126 of the compressed data for the compressed object 118. However, instead of accessing the compressed data sequentially, the archive extractor 108 may use the block map 204 to identify the block sizes 206 of the blocks 114 preceding the fourth block 114, and therefore may seek directly to the start of the fourth block 114. For example, the archive extractor 108 may simply add the block sizes 206 of the first three blocks 114 preceding the fourth block 114, arriving at a total block size for these preceding blocks 114 of 14,271 bytes. The archive extractor 108 may then advance from the start address 126 of the compressed data to the calculated offset, which represents the beginning of the fourth block 114. The archive extractor 108 may then extract the fourth block 114 and invoke the compression technique 110 to expand the fourth block 114, thereby regenerating the fourth segment 112. In this manner, the archive extractor 108 may utilize the block map 204 generated by the archive generator 106 to achieve random access into the segments 112 of an object 102 stored in the archive 104 in accordance with the techniques presented herein.

As further illustrated in the exemplary scenario 200 of FIG. 2, the block map 204 may be stored in the archive 104 as an ordinary object of the object set. This aspect of the techniques presented herein may present some advantages over other techniques for recording the block sizes 206 of respective blocks 114 comprising the compressed object 118. As a first example, this technique does not depend on the specification of the archive 104 (e.g., any particular formatting aspects or features of the archive 104), and does not alter the specification or disrupt the objects 102 of the object set, but rather comprises a general and simple technique for including the supplemental data in the archive 104. Moreover, this technique may be utilized with virtually any type or format of archive, and may therefore comprise a generalized technique for randomly accessing such archives 104. As a second example, these techniques provide the block size information in a discrete object 102 of the object set. For example, even if an archive generator 106 is not configured to generate and store the block map 204 of an archive 104, a separate tool may be invoked to generate the block map 204 and add it to an existing archive 104. Additionally, an archive extractor 108 for the archive 104 that is configured to utilize block maps 204 for such archives 104 may, upon encountering a block map 204, utilize the information to provide random access, and may also be configured to obscure the presence of the block map 204 as an object 102 of the archive 104.

Additional advantages that may be enabled by storing the block map 204 as an ordinary object 102 of the archive 104 include the use of the block map 204 other than by the archive extractor 108. For example, an archive extractor 108 that is configured to utilize block maps 204 of archives may also be configured to (either optionally or as a standard behavior) present, extract, and enable access to the block map 204 in an equivalent manner as for any other object 102 within the archive 104. Alternatively, this behavior with respect to the block map 204 may be exhibited by any archive extractor 108 that is simply not configured to recognize and utilize the block map 204. In either scenario, while extracting the objects 102 of the archive 104 to a file system, the archive extractor 108 may simply extract the block map 204 and store it as a file in the file system. The block map 204, when stored as an object 102 (e.g., a file) apart from the archive 104, may be useful in many contexts. As a first example, if the block map 204 is formatted in a human-readable manner (e.g., as an extensible markup language (XML) object), a user may directly examine the block map 204 in order to utilize the information or to develop tools for automatically utilizing such information. As a second example, tools other than the archive extractor 108 may consume the information presented in the block map 204, e.g., to index the contents of the archive 104, to verify the integrity of the archive 104, and/or to compare the archive 104 with an updated version of the archive 104 in order to identify the changes to the archive 104. As a third example, this generalized technique may be implemented in a generalized layer of the computing environment; e.g., when the operating system detects the extraction of a block map 204 from an archive 104, the operating system may consume the information in the block map 204 and may participate in the fulfillment of requests to access the contents of the archive 104 in a random-access manner. These and other advantages may be achievable through the representation of the block sizes 206 of the blocks 114 in a block map 204 stored within an archive 104 as an object 102 of the object set in accordance with the techniques presented herein.

### C. Primary Embodiments

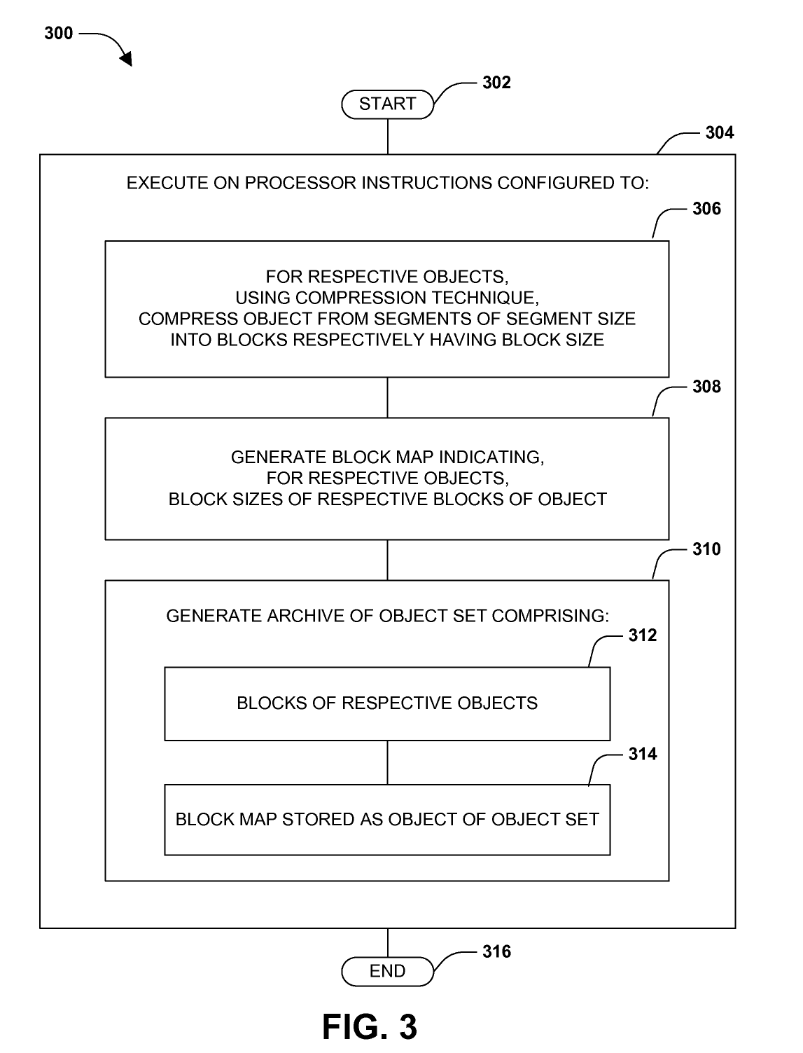

FIG. 3 presents a first embodiment of these techniques, illustrated as an exemplary method 300 of generating an archive 104 compressing an object set comprising at least one object 102 having an uncompressed size and comprising segments 112 of a segment size 202. The exemplary method 300 may be implemented, e.g., as a set of software instructions stored in a memory component (e.g., a system memory circuit, a platter of a hard disk drive, a solid state storage device, or a magnetic or optical disc) of a device having a processor and a compression technique 110, that, when executed by the processor of the device, cause the processor to perform the techniques presented herein. The exemplary method 300 begins at 302 and involves executing 304 the instructions on the processor. More specifically, the instructions are configured to, for respective objects 102, using the compression technique 110, compress 306 the object 102 from the segments 112 of the segment size 202 into blocks 114 respectively having a block size 206. The instructions are also configured to generate 308 a block map 204 indicating, for respective objects 102, the block sizes 206 of respective blocks 114 of the object 102. The instructions are also configured to generate 310 an archive 104 of the object set, the archive 104 comprising the blocks 312 of respective objects 102, and the block map 314 stored within the archive 104 as an object 102 of the object set. In this manner, the exemplary method 300 of FIG. 3 causes the processor of the device to compress the objects 102 into an archive 104 that enables random access within the objects 102 stored therein through the generation and inclusion of a block map 204, and so ends at 316.

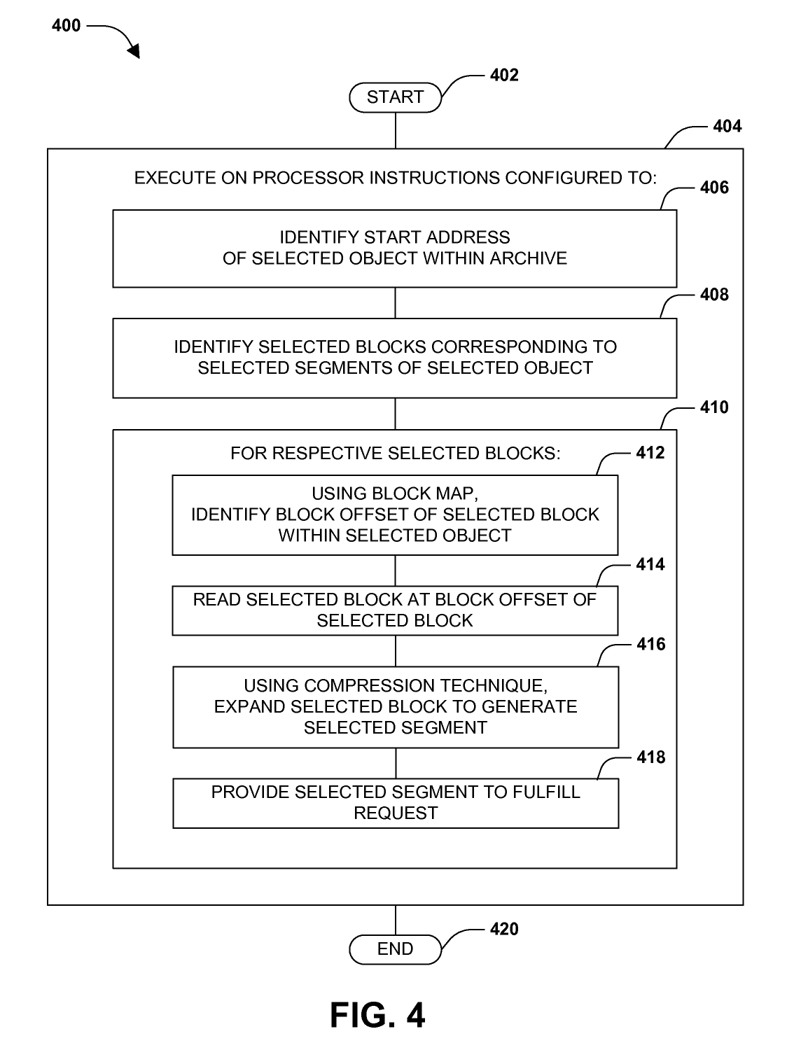

FIG. 4 presents a second embodiment of these techniques, illustrated as an exemplary method 400 of fulfilling a request to read at least one selected segment 112 of a selected object 102 stored in an archive 104. The selected object 102 may have been compressed with a compression technique 110, wherein particular segments 112 of the object 102, having a segment size 202, are stored as blocks 114 respectively having a block size 206. Moreover, this exemplary method 400 may be applied to an archive 104 having a block map 204 specifying a block size 206 for respective blocks 114 of at least one object 102 stored within the archive 104. The exemplary method 400 may be implemented, e.g., as a set of software instructions stored in a memory component (e.g., a system memory circuit, a platter of a hard disk drive, a solid state storage device, or a magnetic or optical disc) of a device having a processor and a compression technique 110, that, when executed by the processor of the device, cause the processor to perform the techniques presented herein. The exemplary method 400 begins at 402 and involves executing 404 the instructions on the processor. More specifically, the instructions are configured to identify 406 a start address 126 of the selected object 102 within the archive 104. The instructions are also configured to identify 408 selected blocks 114 corresponding to the selected segments 112 of the selected object 102. The instructions are also configured to, for respective 410 selected blocks 114 of the selected object 102 in the archive 104, using the block map 204, identify 412 a block offset of the selected block 114 within the selected object 102, and read 414 the selected block 114 at the block offset of the selected object 102. The instructions are also configured to, for respective 410 selected blocks 114, using the compression technique 110, expand 416 the selected block 114 to generate at least one selected segment 202, and provide 418 the selected segment 202 to fulfill the request. In this manner, the exemplary method 500 enables random access within the objects 102 of the archive 104 through the use of a block map 202 in accordance with the techniques presented herein, and so ends at 420.

Still another embodiment involves a computer-readable medium comprising processor-executable instructions configured to apply the techniques presented herein. Such computer-readable media may include, e.g., computer-readable storage media involving a tangible device, such as a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD-R, DVD-R, or floppy disc), encoding a set of computer-readable instructions that, when executed by a processor of a device, cause the device to implement the techniques presented herein. Such computer-readable media may also include (as a class of technologies that are distinct from computer-readable storage media) various types of communications media, such as a signal that may be propagated through various physical phenomena (e.g., an electromagnetic signal, a sound wave signal, or an optical signal) and in various wired scenarios (e.g., via an Ethernet or fiber optic cable) and/or wireless scenarios (e.g., a wireless local area network (WLAN) such as WiFi, a personal area network (PAN) such as Bluetooth, or a cellular or radio network), and which encodes a set of computer-readable instructions that, when executed by a processor of a device, cause the device to implement the techniques presented herein.

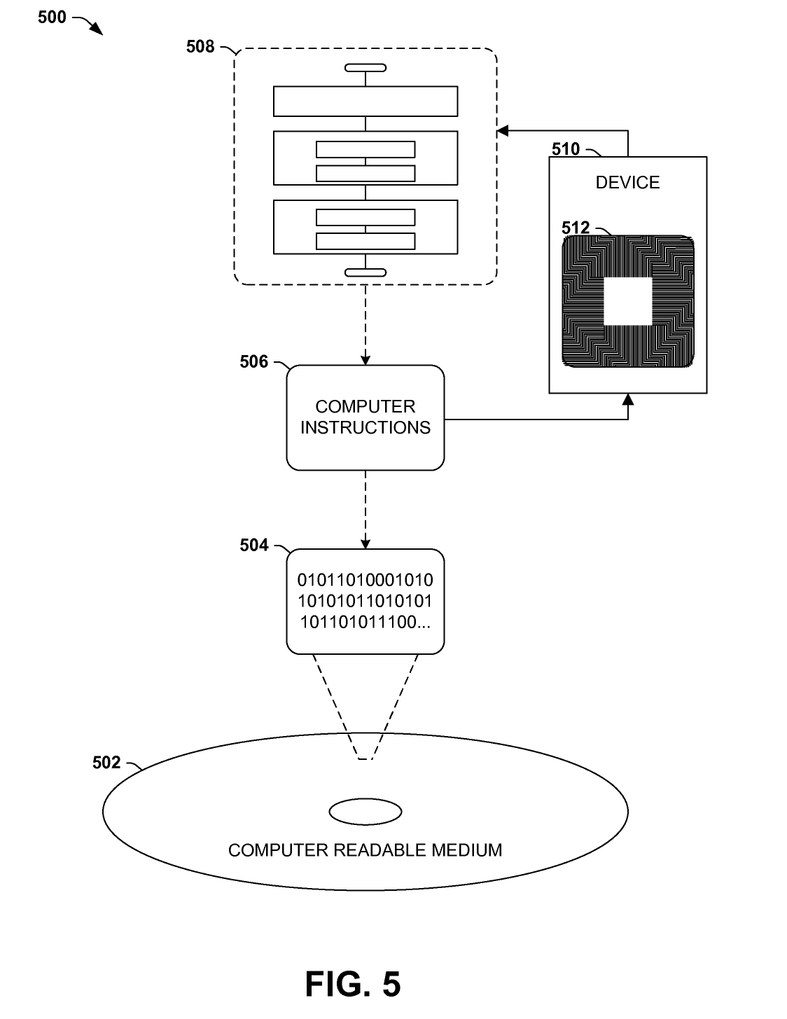

An exemplary computer-readable medium that may be devised in these ways is illustrated in FIG. 5, wherein the implementation 500 comprises a computer-readable medium 502 (e.g., a CD-R, DVD-R, or a platter of a hard disk drive), on which is encoded computer-readable data 504. This computer-readable data 504 in turn comprises a set of computer instructions 506 that, when executed on a processor 512 of a device 510, cause the device to operate according to the principles set forth herein. In one such embodiment, the processor-executable instructions 506 may be configured to perform a method of generating an archive comprising one or more compressed objects, such as the exemplary method 300 of FIG. 3. In another such embodiment, the processor-executable instructions 506 may be configured to implement a system for fulfilling a request to access a particular portion of an object 102 stored in archive 104, such as the exemplary method 400 of FIG. 4. Some embodiments of this computer-readable medium may comprise a nontransitory computer-readable storage medium (e.g., a hard disk drive, an optical disc, or a flash memory device) that is configured to store processor-executable instructions configured in this manner. Many such computer-readable media may be devised by those of ordinary skill in the art that are configured to operate in accordance with the techniques presented herein.

### D. Variations

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the exemplary method 300 of FIG. 3 and the exemplary method 400 of FIG. 4) to confer individual and/or synergistic advantages upon such embodiments.

### D1. Scenarios

A first aspect that may vary among embodiments of these techniques relates to the scenarios wherein such techniques may be utilized. As a first variation of this first aspect, these techniques may be implemented in many types of archive generators 106 and/or archive extractors 108, including standalone executable binaries invoked by users and/or automated processes, an executable binary included with a self-extracting archive 104, a storage system such as a file system or a database system, a server such as a webserver or file server, a media rendering application, and an operating system component configured to compress objects 102 stored on storage devices.

As a second variation of this first aspect, the archives 104 may include many types of objects 102, including media objects such as text, pictures, audio and/or video recordings, applications, databases, and email stores. Additionally, such objects 102 may be stored in volatile memory; on locally accessible nonvolatile media (e.g., a hard disk drive, a solid-state storage device, a magnetic or optical disk, or tape media); or remotely accessed (e.g., via a network). In particular, the techniques presented herein may be useful for accessing objects 102 of archives 104 in scenarios wherein the reduction of seeks and reads within the archive 104 may considerably improve the performance of the accessing. As a first example, where the objects 102 are stored in archives 104 accessed over a network, the latency and comparatively low throughput of the network (particularly low-bandwidth networks) may noticeably improve the performance of the accessing. As a second example, the accessing of objects 102 within archives 104 on a device having limited computational resources (e.g., a portable device having a comparatively limited processor) may be noticeably improved through the use of the techniques presented herein.

As a third variation of this first aspect, these techniques may be used with archives 104 of many different types and specifications, including a uuencode/uudecode format, a tape archive (tar) format, a GNU Zip (gzip) archive format, a CAB archive format, and a ZIP archive format, and a Roshal Archive (RAR) format, or any variant thereof.

As a fourth variation of this first aspect, many types of lossless and/or lossy compression techniques 110 may be utilized, where some compression techniques 110 may be more adept at compressing a particular type of data than other compression techniques 110.

As a fifth variation of this first aspect, these techniques may be utilized to compress many types of objects 102 in an archive 104, including text documents, web documents, images, audio and video recordings, interpretable scripts, executable binaries, data objects, databases and database components, and other compressed archives. A particular type of object 102 that may be advantageously stored according to the techniques presented herein is a media object that is to be rendered in a streaming manner. In such scenarios, a user or application may often utilize seek operations to access different portions of the object 102; and as compared with sequential-access techniques (including the exemplary scenario 100 of FIG. 1), the random access enabled by the techniques presented herein may considerably improve the access rate for various portions (particularly latter portions) of an object 102. Those of ordinary skill in the art may devise many such scenarios wherein the techniques presented herein may be advantageously utilized.

### D2. Generating Archive

A second aspect that may vary among embodiments of these techniques relates to the manner of generating an archive 104. As a first variation of this second aspect, the block map 204 may be generated concurrently with the archive 104 (e.g., while the compression technique 110 is applied by the archive generator 106 to compress the objects 102 of the object set into blocks 114 having a block size 202), and may be stored as an object 102 during the generation of the archive 104. Alternatively, the block map 204 may be generated after the archive 104 is substantially or fully generated, and may request to add the block map 204 to the archive 104, or to generate a second archive 104 adding the block map 204 to the first archive 104.

As a second variation of this second aspect, the block map 204 may be formatted in many ways, including a binary format, a data structure, or a text file. In particular, it may be advantageous to format the block map 204 in a human-readable manner, and/or in a manner that may be easily utilized by external tools, such as an extensible markup language (XML) document formatted according to an XML schema.

As a third variation of this second aspect, the block map 204 may specify the block sizes 206 of the blocks 114 in various ways. In particular, the blocks 114 may be bit-aligned or byte-aligned within the archive 104, and the block map 204 may indicate the block sizes 202 of the blocks 114, respectively, as a bit count or a byte count. Alternatively, the block map 204 may specify the block sizes 204 as a compression ratio of respective blocks 114, e.g., as a percentage of the segment size 202.

As a fourth variation of this second aspect, in addition to specifying the block sizes 204 of the blocks, the block map 204 may specify additional information for respective objects 102, including the names of the object 102, the uncompressed sizes of the object 102, the segment size 202 of the segments 112 of the object 102, the compression ratio of the object 102, and the compression technique 110 used to compress and store the object 102. Alternatively or additionally, the block map 204 may omit some information for respective objects 102. As a first such example, if a standard segment size 202 is defined, the block map 204 may specify the segment size 202 of an object 102 if different from the standard segment size 202, and may otherwise omit the segment size 202. As a second such example, if an object 102 is stored in the archive 104 in an uncompressed manner (such that the block sizes 202 of the blocks 114 are equal to the segment sizes 202 of the segments 112), the block map 204 may omit the block sizes 202 for the object 102. Those of ordinary skill in the art may devise many such variations in the generation of an archive 104 including a block map 204 in accordance with the techniques presented herein.

### D3. Accessing Archive

A third aspect that may vary among embodiments of these techniques involves the manner of using the block map 204 to access an archive 104. As a first variation of this third aspect, the block map 204 may be used by the archive extractor 108 to fulfill requests to access a portion of an object 102 stored in the archive 104. Alternatively, the block map 204 may be consumed and used by an external tool apart from the archive extractor 108. For example, the archive extractor 108 may be configured to extract the block map 204 in a similar manner as any other object 102 of the archive 104, and an external tool may consume the extracted block map 204 in order to provide random access to the objects 102 of the archive 104.

As a second variation of this third aspect, in addition to the accesses techniques presented in FIG. 2 and FIG. 4, the block map 204 may include additional information that facilitates access to the archive 104. As one such example, if the archive 104 precedes each object 102 with a local header 116 (and indicates the start address 126 of the object 102 according to the start address 124 of the local header 116), and if the size of the local header 116 may vary for different objects 102 the block map 204 may specify the size of the local header 116 of the object 102 in order to expedite access to the objects 102 of the archive 104. For example, without the local header information 116, an embodiment may access an object 102 by first consulting the central header 122 to identify the start address 124 of the local header 116; read the local header 116, in part, to determine its size; and identify the end of the local header 116 as the start address 126 of the object 102. However, if the block map 204 includes the local header size of the local header 116, an object 102 may be accessed without seeking to and reading the local header 116; rather, the start address 126 of the object 102 may be simply calculated as the sum of the start address 124 of the local header 116 and the size of the local header 116. This inclusion may therefore avoid seeking to the start of the local header 116 and reading the local header 116 while fulfilling the request to access the object 102, thereby expediting the fulfillment of the request (particularly where extraneous seeks impose a significant performance penalty, such as while accessing objects 102 over a network).

As a third variation of this third aspect, an embodiment of these techniques may use the information in the block map 204 to infer other information about the archive 104. In particular, in some scenarios, the segment size 202 for an object 102 may be consistent for all segments 112 the object 102 except the last segment 112; e.g., if the total size of the object 102 is not a multiple of the segment size 202, then the last segment 112 may present a variable size. However, the last block 114 of the object 102, corresponding to the last segment 112 of the object 102, may not be strictly limited to the size of the last segment 112; e.g., the compression technique 110 may pad the size of the last segment 112 with zero values up to the segment size 202 before compressing it into the last block 114. Therefore, upon decompressing the last block 114, an embodiment of these techniques may have difficulty determining the correct size of the last segment 112 (e.g., whether to trim trailing zero values of the segment 112, and how many zeroes to trim). The block map 204 may facilitate this determination, e.g., by directly specifying the size of the last segment 112, or by specifying the total uncompressed size of the object 102, from which the size of the last segment 112 may be inferred (e.g., as the modulus of the total uncompressed size of the object 102 and the segment size 202), and may therefore trim or otherwise adjust the last segment 112 as an accurate decompression of the compressed object 118.

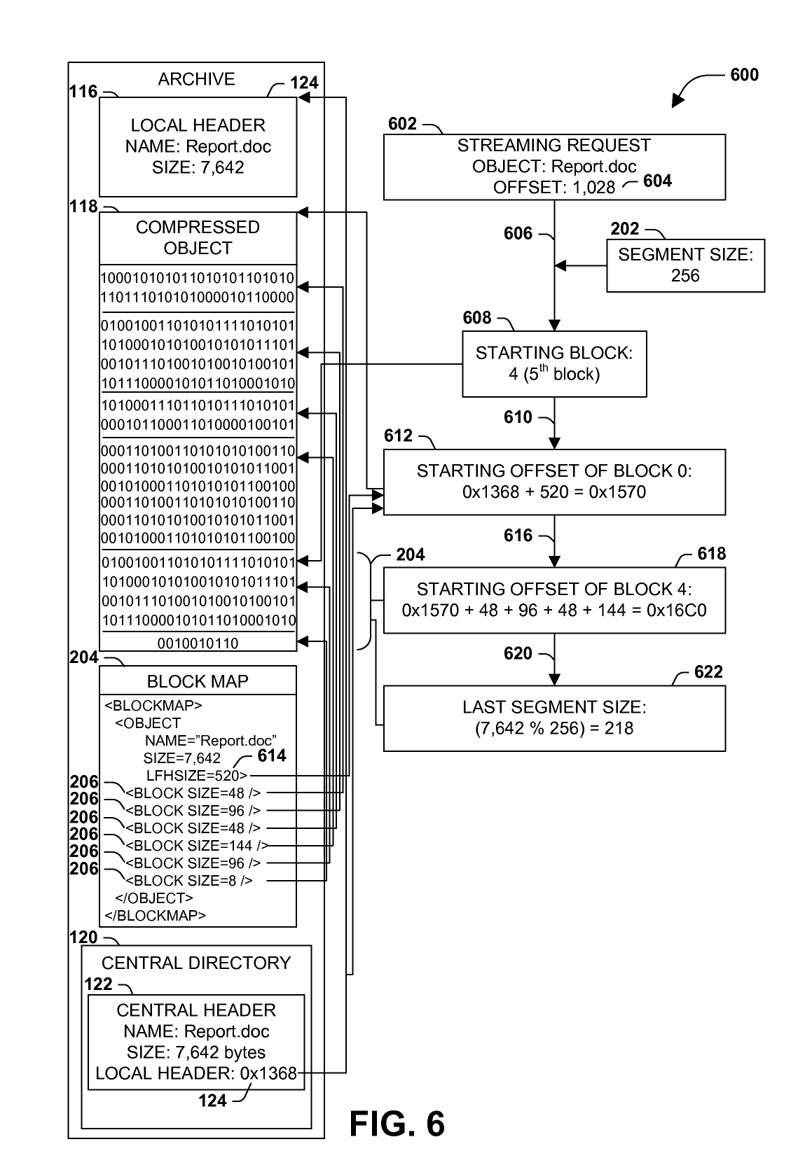

FIG. 6 presents an illustration of an exemplary scenario 600 featuring the application of several of these variations while fulfilling a request to access an object 102 of an archive 104. In this exemplary scenario 600, the archive 104 comprises a compressed object 118 that is specified by a request 602 to provide streaming access to the object 102, and specifying a location 604 within the uncompressed object 102 where the access is to begin. In order to fulfill this request 602, a first calculation 606 may be performed (using the segment size 202) in order to calculate the starting block 608 associated with the offset 604 (e.g., dividing the offset 604 by the segment size 202, rounding down, and adding one), thereby identifying the fifth block 114 in the sequence of blocks 114 (or as block 4 if counted as an array index). Next, a second calculation 610 may be performed to identify the start address 612 of the first block 114 of the object 102 within the archive 104 by adding the start address 124 of the local header 116 (specified in the central directory 120) to a local header size 614 specified in the block map 204. Next, a third calculation 616 may be performed to identify the starting address 618 of the fifth block 114, e.g., by adding the start address 612 of the first block 114 the block sizes 206 of the first, second, third, and fourth blocks 206 specified in the block map 204. The device applying these techniques may then seek to the starting address 618 of the fifth block 114, decompress the fifth block 114 to produce the uncompressed segment 112 comprising the location 604 specified in the request 602, and may provide the decompressed data in order to fulfill the request 602. Moreover, the device may infer the last segment size 622 of the last segment 112 of the object 102 based on the total uncompressed size of the object 102 (specified in the block map 204 and/or the central directory 120) and the segment size 202, e.g., by calculating the modulus of the uncompressed size and the segment size 202. In this manner, a device may fulfill the random-access request 602 to access the object 102 within the archive 104 in performant manner by utilizing the block map 204 according to the techniques presented herein.

### D4. Hashcodes

A fourth aspect that may vary among embodiments of the techniques presented herein relates to the inclusion in the block map 204 of hashcodes for respective blocks 114 of the objects 102 of the object set. For example, while generating the block map 204 including the block sizes 206 of respective blocks 204, an embodiment of these techniques may, for respective blocks 114, calculate an original hashcode for the block 114 and/or the segment 112 corresponding to the block 114 using a hashing algorithm, and may store the original hashcode for the block 114 in the block map 204. Additionally, when accessing the blocks 114 of an object 102 in the archive 104 using the block map 204, an embodiment may calculate a current hashcode for the block 114 and/or the segment 112 corresponding to the block 114, and compare the current hashcode with the original hashcode. A successful comparison may indicate that the block 114 has not been changed since the generation of the archive 104, while a failed comparison may indicate that the contents of the block 114 and the corresponding segment 112 have been altered since the block 114 was initially stored in the archive 104.

As a first variation of this fourth aspect, hashcodes may be calculated for respective blocks 114 in various ways. As a first such example, after the compression technique 110 generates a block 114, an embodiment may apply a hashing algorithm to calculate the original hashcode of the block 114 and store the original hashcode in the block map 204; and, upon accessing a block 204 in response to a request 602, may calculate the current hashcode of the block 114, and compare the current hashcode with the original hashcode of the block 114. Alternatively, an embodiment may calculate hashcodes for respective segments 112 of the respective objects 102. For example, while storing a block 114, an embodiment may be configured to use the hashing algorithm to calculate an original hashcode of the segment 112 corresponding to the block 114, and to store and associate the original hashcode of the segment 112 with the corresponding block 114in the block map 204. Additionally, upon decompressing a block 114, the embodiment may calculate a current hashcode of the segment 112 corresponding to the block 114, and compare the current hashcode of the segment 112 with the original hashcode of the segment 112. As a second such example, hashcodes may be calculated with different granularities; e.g., one hashcode may be generated for each block 114 or segment 112; for a portion of a block 114 or segment 112; or for a plurality of blocks 114 or segments 112. In one such scenario, the archive 104 may de-duplicate the blocks 114 of the objects 102 of the archive 104, and the block map 104 may specify a hashcode for each de-duplicated block 114 of the objects 102. Moreover, two or more sets of hashcodes may be calculated with different granularities (e.g., a first hashcode for respective sets of ten blocks 114 of respective objects 102, and a second hashcode for respective single blocks 114 of the objects 102), thereby enabling a rapid initial identification of the general areas of an object 102 that have been altered, with a zeroing-in on a changed portion of an object 102 by comparing hashcodes of finer granularities of the blocks 114 of the object 102.

As a second variation of this fourth aspect, the calculation of hashcodes using hashing algorithms may be performed in many ways. As a first example, many hashing algorithms may be utilized, such as MD5, SHA-256, RIPEMD, and WHIRLPOOL. The selection among various hashing algorithms may be performed in view of many considerations, including the availability of the hashing algorithms; the efficiency of the hashing algorithm (particularly for performing the comparisons in a just-in-time manner while streaming or otherwise accessing the data of an object 102); and the reliability of the hashing algorithm, such as the consistency of the hashing algorithm, the frequency and nature of collisions among different blocks 114 and/or segments 112 producing the same hashcode; and the presence or absence of exploits or cracks of the hashing algorithm, such as the ability to fabricate data sets having a target hashcode. In some scenarios, a single hashing algorithm may be available (e.g., an implementation of the block map 204 may specify a single hashing algorithm). Alternatively, the selection of a hashing algorithm among a set of available hashing algorithms may be relegated to an embodiment of these techniques, a device, an application, and/or a user generating the archive 104. The block map 204 may indicate the selected hashing algorithm used to calculate the hashcodes for the blocks 206. Additionally, the block map 204 may permit different hashing algorithms to be used for different objects 102 and/or for different blocks 114 or segments 112 of an object 102. As a second example, a hashing algorithm may be locally stored, or may be remotely accessible. As one such example, one or more hashing algorithms may be associated with a uniform resource identifier (URI), such as a distinctive name, location, or network address where details or implementations of a particular hashing algorithm are located, and the hashing algorithm may be identified in the block map 204 according to the URI of the hashing algorithm. This variation may enable a device that does not have local access to a particular hashing algorithm to retrieve details or an implementation (e.g., a compiled class object or a link library) of the hashing algorithm from an online source in order to calculate hashcodes for the blocks 114 of the objects 102 of an archive 104. As a third example, a hashing algorithm may have an identifiable reliability (e.g., a resistance to attempts to circumvent the hashing algorithm, such as by identifying techniques for altering data in a manner that does not change the hashcode). If a selected hashing algorithm is identified as an unreliable hashing algorithm, an embodiment of these techniques may refuse to calculate and/or compare hashcodes generated by the unreliable hashing algorithm (e.g., refusing to generate an archive 104 including hashcodes generated by the unreliable hashing algorithm, and/or refusing to compare the original hashcodes of an archive 104 with the current hashcodes of the archive 104 that were generated by an unreliable hashing algorithm). Such refusal may reduce opportunities to exploit such unreliable hashing algorithms. As a fourth example, two or more hashcodes may be calculated for each block 104 using different hashing functions, thereby providing redundancy and resiliency of the hashing techniques in case one hashing algorithm is compromised or demonstrated to be inconsistent.

The calculation and comparison of hashcodes stored in the block map 204 may enable many uses with respect to the archive 104 and the objects 102 contained therein. In general, several formats of archives 104 include such hashing techniques, e.g., a hashing of the entire archive 104 and/or respective objects 102 of the archive 104; however, such techniques may be determine whether the archive 104 or a particular object 102 was updated, but not the position within an object 102 where data has been altered. By contrast, the comparisons of hashcodes for respective blocks 114 in accordance with the techniques presented herein may enable a detection of the particular locations (e.g., blocks 114) within respective objects 102 that have been changed.

As a first exemplary use, the comparisons may be performed to verify that the archive 104 has not been altered since it was originally created. Such alterations may be inadvertent (e.g., due to data corruption or communication problems), benign (e.g., a post-generation update of the archive 104), and/or malicious (e.g., an attempt to change or fabricate data within the archive 104). However, and particularly in the case of malicious alteration, such techniques may be inadequate if the hashcodes stored in the block map 204 of the altered blocks 104 are also changed to match the altered blocks 104. Therefore, it may be advantageous to protect the hashcodes with a cryptographic signature. For example, an embodiment of these techniques may have access to a cryptographic signature algorithm (e.g., an implementation of the Rivest-Shamir-Adleman (RSA) asymmetric encryption algorithm), may enable a user generating an archive 104 to cryptographically sign the hashcodes with a private key, and may store the cryptographic signature in the archive 104 (e.g., in the block map 204). Further, while verifying the original hashcodes of the blocks 114, the embodiment may verify the cryptographic signature of the hashcodes (e.g., using a public key corresponding to the private key with which the hashcodes were cryptographically signed) in order to determine, in addition to whether the blocks 114 remaining unaltered since the archive 104 was originally generated, whether the hashcodes are altered or unaltered since the generation of the archive 104.

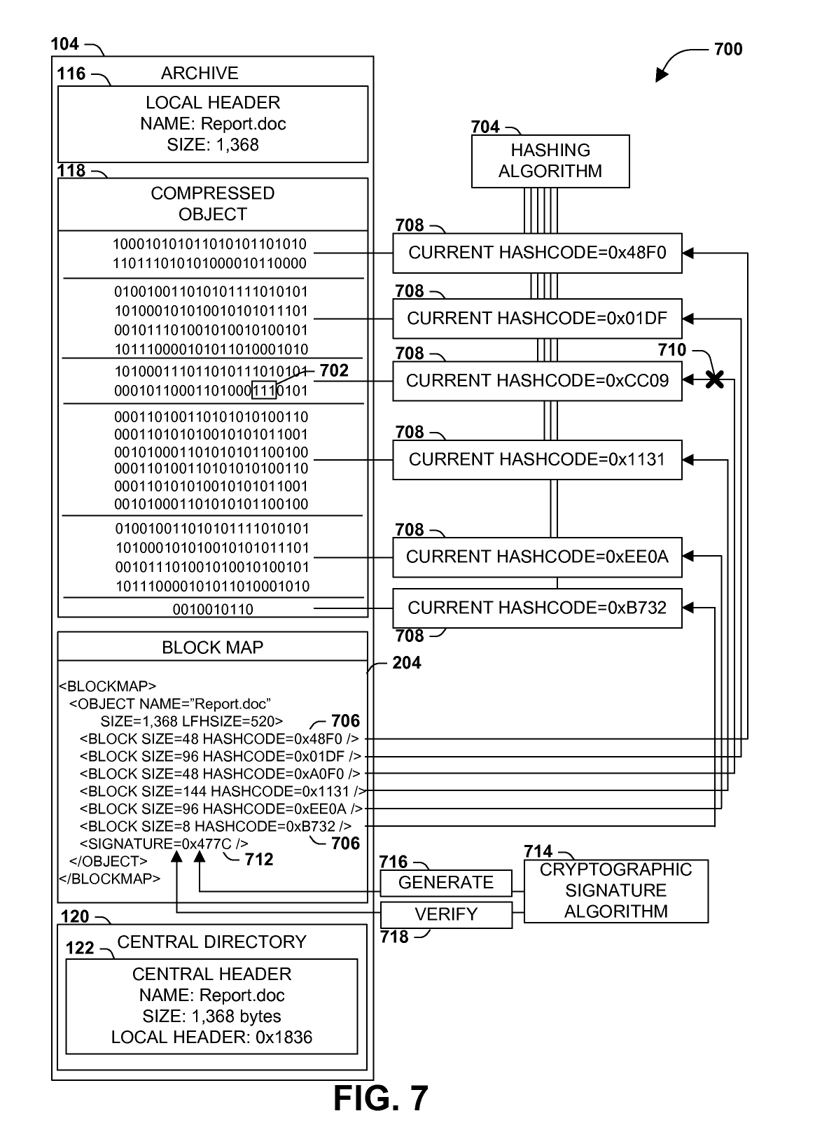

FIG. 7 presents an illustration of an exemplary scenario 700 featuring a detection of alterations of the blocks 114 of an object 102 of an archive 104 through the calculation and comparison of hashcodes generated by a hashing algorithm 704. In this exemplary scenario 700, when the archive 104 is generated, a hashing algorithm 704 is utilized to calculate an original hashcode 706 for respective blocks 114 of the objects 102 stored in the archive 104, and the original hashcodes 706 may be stored in the block map 204 for respective blocks 114. Although not shown in the exemplary scenario 700 of FIG. 7, the block map 204 may also identify the hashing algorithm 704 used to calculate the original hashcodes 706. In addition, a cryptographic signature algorithm 714 may be utilized to generate and store in the block map 204 a cryptographic signature 712 of the hashcodes 706. However, following the generation of the archive 104, an alteration 702 of a third block 114 may occur within the archive 104. An embodiment of these techniques may detect this alteration 702 (and verify the absence of alterations 702 of the other blocks 114 of the object 102) when accessing the blocks 114. For example, the embodiment may, for respective accessed blocks 114, calculate a current hashcode 708 using the same hashing algorithm 702, and for respective blocks 114, compare the current hashcode 708 with the original hashcode 706 stored in the block map 204. The embodiment may therefore detect an inconsistency 710 of the current hashcode 708 and the original hashcode 706 indicating the alteration 702 of the third block 702 of the object 102. Moreover, the embodiment may use the cryptographic signature algorithm 714 to verify 718 the cryptographic signature 712 of the block map 204, and thus verify that the original hashcodes 706 have not been altered since the archive 104 was generated. In this manner, the original hashcodes 706 and the cryptographic signature 712 of the block map 204 may be used to determine the integrity and consistency of the archive 104.

A second exemplary use of hashcodes included in a block map 204 involves the detection of updates to an archive 104, and, optionally, an automated updating of the archive 104 to an updated version of the archive 104. In this example, after an archive 104 is generated, it may be updated by altering one or more blocks 114 of one or more objects 102, and also updating the block map 204 of the archive 104. For example, the archive 104 may comprise a collection of media objects that is supplemented with new or edited media objects, or an application of a particular version that is updated with a later version of the application. In such scenarios, the nature, extent, and other details of an update may be determined by comparing the block map 204 of the archive 104 with the block map 204 of the updated archive 104. In particular, the embodiment may perform a comparison of the hashcodes of respective blocks 116 of the objects 102 of the archives 104 in order to identify updated blocks 116. Additionally, an embodiment may then update the archive 104 by retrieving the updated blocks 116 from the updated archive 104, apply the updated blocks 116 to the archive 104 (e.g., substituting respective blocks 114 with a corresponding updated block 114), and replace the original hashcode of the block 114 in the block map 204 with the current hashcode of the updated block 114. In this manner, an embodiment may automatically update an archive 104 to an updated version of the archive 104 while reducing the amount of data that is substituted (e.g., instead of obtaining the entire updated archive 104 or substituting entire objects 102 that have been updated, the embodiment may retrieve and substitute only the updated blocks 114 of the objects 102 of the archive 104).

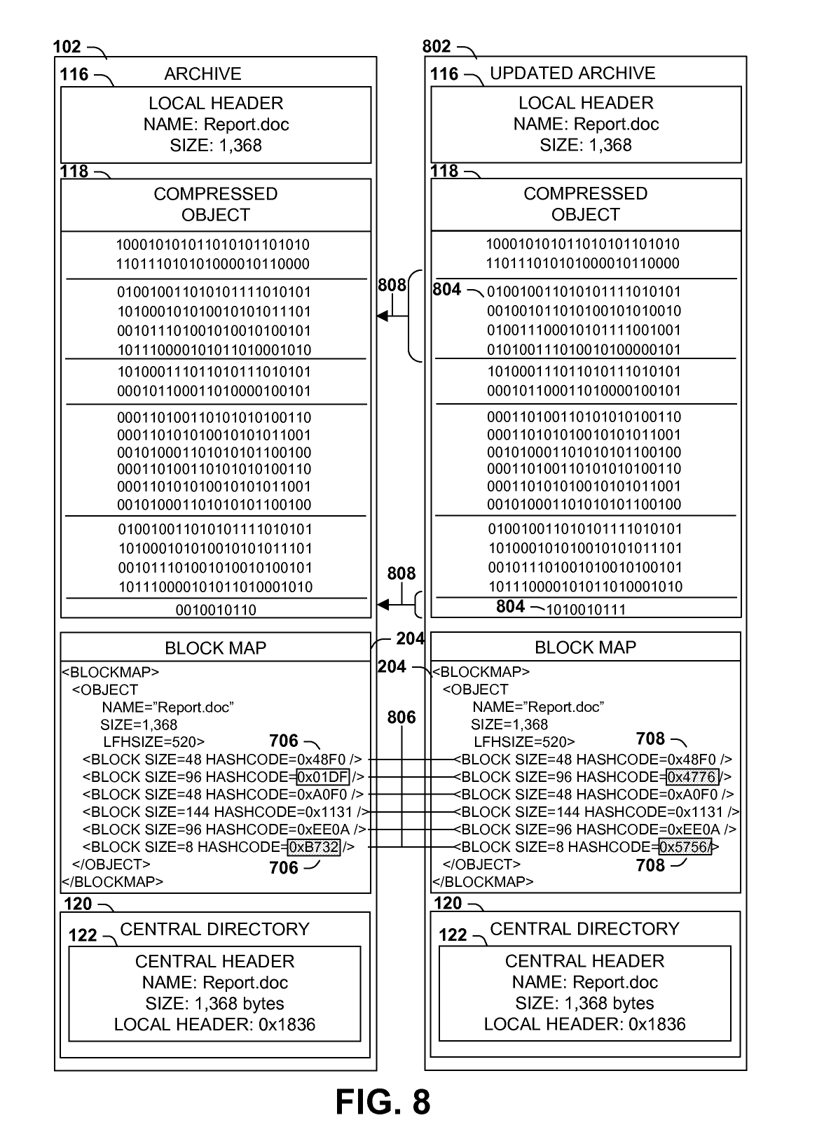

FIG. 8 presents an illustration of an exemplary scenario 800 featuring an automated updating of an archive 104 to match an updated archive 802. In this exemplary scenario 800, the updated archive 802 includes updates 804 to two blocks 114 of the archive 104 have been in the updated archive 802, as reflected in the current hashcodes 708 of the block map 204 of the updated archive 802. An embodiment may update the archive 104 by retrieving the block maps 204 of the archive 104 and the updated archive 802 and performing a comparison 806 of the original hashcodes 706 in the block map 204 of the archive 104 with the updated hashcodes 708 in the block map 204 of the updated archive 802. This comparison 806 may indicate a mismatch of the blocks 114 to which the updates 84 have been applied in the updated archive 802. Moreover, the embodiment may substitute 808 the blocks 114 in the archive 104 with the updated blocks 114 in the updated archive 802, and may also update the original hashcodes 706 of such blocks 114 in the block map 204 of the archive 104 with the current hashcodes 708 of the updated blocks 114. In this manner, the archive 104 may be updated to match the update archive 802 in an automated and efficient manner (e.g., retrieving from the updated archive 802 only the block map 204 and the updated blocks 114 of the updated archive 804) through the comparison 806 of the hashcodes stored in the block maps 204. Those of ordinary skill in the art may devise many uses of hashcodes that are calculated and stored in the block maps 204 of archives 104 in accordance with the techniques presented herein.

### E. Computing Environment

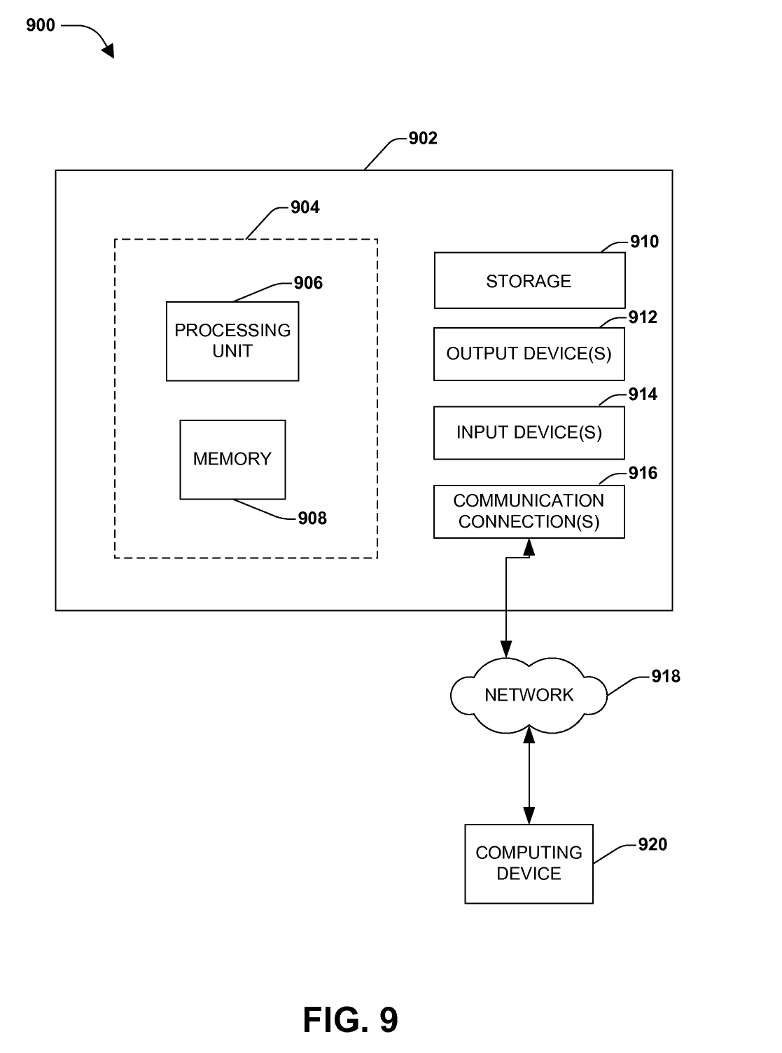

FIG. 9 and the following discussion provide a brief, general description of a suitable computing environment to implement embodiments of one or more of the provisions set forth herein. The operating environment of FIG. 9 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 9 illustrates an example of a system 900 comprising a computing device 902 configured to implement one or more embodiments provided herein. In one configuration, computing device 902 includes at least one processing unit 906 and memory 908. Depending on the exact configuration and type of computing device, memory 908 may be volatile (such as RAM, for example), non-volatile (such as ROM, flash memory, etc., for example) or some combination of the two. This configuration is illustrated in FIG. 9 by dashed line 904.

In other embodiments, device 902 may include additional features and/or functionality. For example, device 902 may also include additional storage (e.g., removable and/or non-removable) including, but not limited to, magnetic storage, optical storage, and the like. Such additional storage is illustrated in FIG. 9 by storage 910. In one embodiment, computer readable instructions to implement one or more embodiments provided herein may be in storage 910. Storage 910 may also store other computer readable instructions to implement an operating system, an application program, and the like. Computer readable instructions may be loaded in memory 908 for execution by processing unit 906, for example.

The term “computer readable media” as used herein includes computer storage media. Computer storage media includes volatile and nonvolatile, removable and non-removable media implemented in any method or technology for storage of information such as computer readable instructions or other data. Memory 908 and storage 910 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 902. Any such computer storage media may be part of device 902.

Device 902 may also include communication connection(s) 916 that allows device 902 to communicate with other devices. Communication connection(s) 916 may include, but is not limited to, a modem, a Network Interface Card (NIC), an integrated network interface, a radio frequency transmitter/receiver, an infrared port, a USB connection, or other interfaces for connecting computing device 902 to other computing devices. Communication connection(s) 916 may include a wired connection or a wireless connection. Communication connection(s) 916 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 902 may include input device(s) 914 such as keyboard, mouse, pen, voice input device, touch input device, infrared cameras, video input devices, and/or any other input device. Output device(s) 912 such as one or more displays, speakers, printers, and/or any other output device may also be included in device 902. Input device(s) 914 and output device(s) 912 may be connected to device 902 via a wired connection, wireless connection, or any combination thereof. In one embodiment, an input device or an output device from another computing device may be used as input device(s) 914 or output device(s) 912 for computing device 902.

Components of computing device 902 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 902 may be interconnected by a network. For example, memory 908 may be comprised of multiple physical memory units located in different physical locations interconnected by a network.

Those skilled in the art will realize that storage devices utilized to store computer readable instructions may be distributed across a network. For example, a computing device 920 accessible via network 918 may store computer readable instructions to implement one or more embodiments provided herein. Computing device 902 may access computing device 920 and download a part or all of the computer readable instructions for execution. Alternatively, computing device 902 may download pieces of the computer readable instructions, as needed, or some instructions may be executed at computing device 902 and some at computing device 920.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

### F. Usage of Terms

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of generating an archive compressing an object set comprising at least one object comprising segments of a segment size on a device having a processor and a compression technique, the method comprising:
executing on the processor instructions configured to:
for respective objects, using the compression technique, compress the object from the segments of the segment size into blocks respectively having a block size;
generate a block map indicating, for respective objects, the block sizes of respective blocks of the object; and
generate an archive of the object set comprising:
the blocks of respective objects; and
the block map stored as an object of the object set.

2. The method of claim 1:
the archive of the object set byte-aligning respective blocks of respective objects; and
the block map indicating the block sizes of respective blocks of respective objects as a byte count.

3. The method of claim 1:
the objects stored in the archive comprising at least one uncompressed object that is not compressed with a compression technique; and
generating the block map comprising: generating the block map indicating, for respective compressed objects compressed with a compression technique, the block sizes of respective blocks.

4. The method of claim 1:
respective objects preceded in the archive by a local header having a local header size; and
the block map indicating, for respective objects, the local header size of the local header.

5. The method of claim 1:
the device having access to a hashing algorithm configured to generate hashcodes;
the instructions configured to, for respective segment of respective objects, calculate an original hashcode of the segment with the hashing algorithm; and
the block map indicating, for respective blocks, the original hashcode of the segment corresponding to the block.

6. The method of claim 5:
the device comprising a cryptographic signature algorithm configured to generate cryptographic signatures; and
the instructions configured to:
generate a cryptographic signature of the block map, and
store the cryptographic signature of the block map.

7. The method of claim 5:
the device having access to at least two hashing algorithms;
the instructions configured to receive a selected hashing algorithm to be used to calculate hashcodes of the segments of at least one object;
calculating hashcodes of segments comprising: for respective segments of respective objects, calculating an original hashcode of the segment with the selected hashing algorithm; and
the block map identifying, for respective objects, the selected hashing algorithm used to calculate the original hashcodes of the segments of the object.

8. The method of claim 7:
respective hashing algorithms associated with a uniform resource identifier; and
identifying the selected hashing algorithm in the block map comprising: for respective objects, storing in the block map the uniform resource identifier of the hashing algorithm used to calculate the original hashcodes of the segments of the object.

9. A method of fulfilling a request to read at least one selected segment of a selected object compressed with a compression technique from segments having a segment size to blocks having a block size and stored within an archive, the method performed on a device having a processor and comprising:
executing on the processor instructions configured to:
identify a start address of the selected object within the archive;
identify selected blocks corresponding to the selected segments of the selected object; and
for respective selected blocks:
using the block map, identify a block offset of the selected block within the selected object;
read the selected block at the block offset of the selected object;
using the compression technique, expand the selected block to generate at least one selected segment; and
provide the selected segment to fulfill the request.

10. The method of claim 9, the instructions configured to, while extracting objects of the archive, extract the block map as an object of the archive.

11. The method of claim 9:
at least one object compressed as segments of a segment size;
the block map storing an uncompressed size of respective objects;
the request including at least a portion of a last segment of a selected object; and
the instructions configured to infer a size of the last segment according to the segments size, a block count of blocks comprising the object, and the uncompressed size of the object.

12. The method of claim 9:
the block map storing, for respective objects, a local header size of a local header of the object; and
identifying a block offset of a selected object comprising: adding the local header size of the local header of the selected object to the block offset of the selected block within the object.

13. The method of claim 9:
the device having access to a hashing algorithm configured to generate hashcodes;
the block map storing, for respective blocks of respective objects, an original hashcode of the segment corresponding to the block; and
the instructions configured to, after expanding a block:
calculate a current hashcode of the segment corresponding to the block, and
compare the current hashcode of the segment with the original hashcode of the segment.

14. The method of claim 13:
the device comprising a cryptographic signature algorithm configured verify cryptographic signatures;
the block map comprising a cryptographic signature of the original hashcodes; and
the instructions configured to verify the cryptographic signature of the original hashcodes.

15. The method of claim 13:
the device having access to an updated archive; and
the instructions configured to:
read the block map of the updated archive; and
for respective blocks of respective objects of the object set:
perform a comparison of the original hashcode of the block in the block map of the archive with a hashcode of the block in the block map of the updated archive; and
based on the comparison, identify updated blocks of the object set that have been updated in the updated archive.

16. The method of claim 15, the instructions configured to, for respective updated blocks:
retrieve the updated block from the updated archive;
substitute respective blocks with a corresponding updated block; and
replace the original hashcode of the block in the block map with the current hashcode of the updated block.

17. The method of claim 13:
the device having access to at least two hashing algorithms;
the block map identifying, for respective objects, the selected hashing algorithm used to calculate the original hashcodes of the segments of the object; and
calculating a current hashcode of a segment of an object comprising:
identifying the selected hashing algorithm of the object, and
using the selected hashing algorithm, calculate the current hashcode of the segment of the object.

18. The method of claim 17:
respective hashing algorithms associated with a uniform resource identifier; and
identifying the selected hashing algorithm in the block map comprising: using the uniform resource identifier, retrieve the selected hashing algorithm for the object.

19. The method of claim 17:
at least one hashing algorithm comprising an unreliable hashing algorithm; and
comparing a current hashcode of a segment with an original hashcode of the segment comprising: upon determining that the selected hashing algorithm comprises an unreliable hashing algorithm, refusing to compare the original hashcodes of the segment with the original hashcode of the segment.

20. A computer-readable storage medium comprising instructions that, when executed on a processor of a device having access to at least two compression techniques, at least two hashing algorithms respectively configured to generate hashcodes, and a cryptographic signature algorithm configured to generate and compare cryptographic signatures, fulfill requests to read selected segments of selected objects by:
upon receiving a request to generate an archive of at least one object of an object set, the request specifying a selected hashing algorithm to be used to calculate hashcodes of the segments of at least one object, the selected hashing algorithm associated with a uniform resource identifier:
for respective segment of respective objects, calculating an original hashcode of the segment with the selected hashing algorithm;
for respective objects, using the compression technique, compressing the object from the segments of the segment size into blocks respectively having a block size;
generating a central directory;
generating a block map indicating, for respective objects:
an uncompressed size of the object;
for respective blocks, the original hashcode of the segment corresponding to the block;
the block sizes of respective blocks of the object that have been compressed with a compression technique; and
the uniform resource identifier of the selected hashing algorithm;
adding the block map to the central directory;
generating a cryptographic signature of the block map;
generating an archive of the object set comprising:
the blocks of respective objects, the archive byte-aligning respective blocks, respective objects preceded in the archive by a local header having a local header size, and the archive including at least one uncompressed object that is not compressed with a compression technique;
the block map stored as an object of the object set and indicating the local header sizes of the local headers of respective objects; and the cryptographic signature of the block map; and
upon receiving a request to read at least one selected segment of a selected object compressed with a compression technique from segments having a segment size to blocks having a block size and stored within an archive:
verifying the cryptographic signature of the block map;
using the central directory, identifying a start address of the selected object within the archive;
using the block map, identifying selected blocks corresponding to the selected segments of the selected object;
inferring a size of the last segment according to the segments size, a block count of blocks comprising the object, and the uncompressed size of the object; and
for respective selected blocks:
using the block map, identifying a block offset of the selected block within the selected object by adding the local header size of the local header of the selected object and the block offset of the selected block within the object to the start address of the selected object within the archive;
reading the selected block at the block offset of the selected object;
using the compression technique, expanding the selected block to generate at least one selected segment;
identifying the uniform resource identifier identifying a selected hashing algorithm of the object;
using the uniform resource identifier, retrieve the selected hashing algorithm for the object;
upon determining that the selected hashing algorithm does not comprise an unreliable hashing algorithm:
using the selected hashing algorithm, calculating the current hashcode of the segment of the object;
comparing the current hashcode of the segment with the original hashcode of the segment; and
providing the selected segment to fulfill the request.
